(19) United States
(12) Patent Application Publication
(10) Pub. No.: US 2013/0204796 A1
(43) Pub. Date: Aug. 8, 2013

(54) INNOVATION MANAGEMENT

(71) Applicant: Pradeep V. Desai, Bangalore (IN)

(72) Inventor: Pradeep V. Desai, Bangalore (IN)

(73) Assignee: TATA CONSULTANCY SERVICES LIMITED, Mumbai (IN)

(21) Appl. No.: 13/129,315

(22) PCT Filed: Aug. 24, 2010
(86) PCT No.: PCT/IN2010/000555

§ 371 Date: Jun. 18, 2012

(30) Foreign Application Priority Data
May 6, 2010 (IN) 1443/MUM/2010

(51) Int. Cl. G06Q 10/10

(52) U.S. Cl. CPC G06Q 10/101
USPC 705/300

(57) ABSTRACT

The subject matter described herein relates to a system and a method for innovation management. The method is performed to ascertain a current innovation maturity level from a plurality of innovation maturity levels of a unit. In that respect, the system assesses inputs received from the unit to calculate a score of each of a plurality of innovation factors. The score is used to determine the factor strength of each of a plurality of innovation factors for each of the innovation maturity levels. Based on the factor strength, the current innovation maturity level is ascertained for the unit.

### TECHNICAL FIELD

The present subject matter, in general, relates to innovation management, and in particular, to network-based innovation management.

### BACKGROUND

With growing competitive conditions in the dynamic and changing environment of global economy, organizations have been adopting various business strategies to create growth and sustain performance. One such strategy adopted by the organizations is to innovate. Innovation can be defined as the successful exploitation of new ideas to generate new products that add value to the organizations and stakeholders Innovation is a key factor for the organizations to adapt themselves to new constraints and take advantage of new opportunities. Innovation is essential in order to generate long-term stability, growth, returns, and sustainable performance and remain at the leading edge of the industry.

To have innovation as a core of its business strategy, an organization needs to develop its innovation capability, which is an ability to come up with, on a consistent basis, certain novel ideas that deliver both short and long term profits. Conventionally, the organizations have been using firm centric innovations to come up with innovations. In the firm centric innovation approach, organizations themselves generate innovative ideas that relate to development, manufacture, marketing, and distribution of their goods and service for years. Generation of such ideas requires the organizations to allocate various internal resources, such as knowledge, technology, etc. Allocation of these resources results in a high cost to the organizations. Further, in the firm-centric innovations approach, the innovation process is often largely concentrated on the current business and not on a new one, thus limiting the organization's growth to a specific market.

In recent years, organizations have started moving towards open innovations where different organizations work together to increase capacity, improve performance, and lower cost structure. It is a mutually beneficial agreement between two or more units in which resources, knowledge and capabilities are shared. However, in open innovations, the organizations face the issue of compatibility in terms of skill, work culture, etc., due to which the organizations may need to depend on external agencies or consultants for helping the organizations reach a common platform.

### SUMMARY

The subject matter described herein relates to a system and method for implementing network-based innovation. The system involves assisting a unit to improve its internal resources as well as work together with other units to increase the innovation capability of the unit, improve performance and lower cost structure. The system helps units develop their innovation capability that is an ability to come up, consistently, with innovations, i.e., novel ideas that deliver short and long-term profits.

The system provides an interactive method of identifying a maturity level of the unit's innovation capability. The method ascertains a current innovation maturity level from a plurality of innovation maturity levels of the unit. In that respect, the system assesses inputs received from the unit to calculate a score of each of a plurality of innovation factors. The innovation factors are key factors in determining the innovation capability of the unit that are analyzed to determine the current innovation maturity level.

The score is used to determine a factor strength of the innovation factors. The factor strength of the innovation factors is determined for all the innovation maturity levels. Based on the factor strength, the current innovation maturity level of the unit ascertained.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The above and other features, aspects and advantages of the subject matter will be better understood with regard to the following description, appended claims, and accompanying drawings, where:

FIG. 1 illustrates an exemplary network environment for implementing a network-based innovation system, according to an embodiment of the present subject matter.

FIG. 2 illustrates an exemplary computing device implementing the network-based innovation system as described in FIG. 1, according to an embodiment of the present subject matter.

FIG. 3 illustrates an exemplary method for implementing a network-based innovation strategy, according to an embodiment of the present subject matter.

### DETAILED DESCRIPTION

Given the tough competitive conditions around the globe, organizations need to adapt themselves to ever changing market constraints Innovation is one of the key necessities for the organizations to adapt themselves so as to meet the new constraints and take advantage of new opportunities. Innovations can be incremental, disruptive, and radical in nature. Incremental innovation is a gradual improvement to an existing technology, service, product, process, etc. Disruptive innovation can be a new technological innovation, product, or service that eventually overturns the existing dominant technology or product in the market. Radical innovation can be one that explores a new technology, service, product, process, etc., that transform existing markets or industries, or creates new ones.

To this end, a system and method for implementing network-based innovation is disclosed. The network-based innovation pertains to innovations centered on a network of different units, such as various organizations, various departments within a single organization, divisions, groups or teams within a department, or individual innovators within an organization. A network-based innovation system, hereinafter referred to as a system, involves assisting a unit to improve its internal resources as well as work together with other units to increase its innovation capability, improve performance, and lower its cost structure Innovation capability, in the present context, can be understood as the ability of a particular unit to come up, consistently, with innovations, i.e., novel ideas so as to deliver both short-term and long-term profits.

The system provides an interactive method of implementing network-based innovation that identifies a maturity level of the unit's innovation capability. The maturity level can be identified by analyzing strengths and weaknesses of different innovation factors. In one example, about 15 such key innovation factors, which are key factors in determining the innovation capability of the unit, are analyzed to determine the maturity level of the innovation capability of the unit. In one embodiment, the maturity level may be classified into one of six predefined maturity levels. Each of the six maturity level defines a rating for the unit's innovation capability. However, it will be clear to a person skilled in the art that the number of maturity levels and innovation factors have been provided as example and may vary.

The method involves taking inputs from a plurality of units, analyzing the inputs, and providing recommendations, based on the analysis, to strengthen the innovation capability. An assessment module sends one or more questionnaires, such as maturity level questionnaires, factor strength questionnaires, and innovation measurement questionnaires to the units, over the network, and receives the replies to the questionnaires from the units. In one embodiment, separate maturity level questionnaires for each of the incremental, disruptive, and radical innovation can be sent to identify the maturity level for each of the innovations. The maturity level questionnaires include multiple sets of questions, with each set corresponding to a particular innovation factor. The questions may be designed to determine strength and weaknesses of the innovation factors. The questions may also correspond to various maturity levels. Based on the inputs, the assessment module calculates a score to determine the strength of each innovation factor, hereinafter interchangeably referred to as factors.

For the purpose, a threshold method is used that involves assessing factor strength for each maturity level, i.e., assessing a score of each factor for each maturity level and comparing the score with a threshold value for each maturity level. If the score for a particular factor is equal to or above the threshold value for a particular maturity level, then the factor strength is termed as a high factor strength, i.e., the factor strength is strong for the particular maturity level and the factor passes for that particular maturity level. Otherwise, the factor strength is termed as a low factor strength, i.e., the factor strength is weak for the particular maturity level and the particular factor fails for that particular maturity level. Thus, all the maturity levels that have high factor strength for each of the factors are identified and the highest maturity level for which all the factors have high factor strength is selected as a current maturity level of the innovation capability of the unit. In one embodiment, the maturity level for each of the incremental, disruptive, and radical innovation categories can be identified.

Once the factor strength for each of the levels is determined, data having details about the factor strength for each factor is sent to an analysis module. The analysis module analyzes the data to identify weak factors and determines the factors that need to be strengthened to strengthen the weak factors to enable the unit's innovation capability reach next maturity level on the maturity level model. The analysis module prepares a factor matrix having the score of each factor marked against respective maturity levels. Based on the factor matrix, the analysis module identifies the weak factors and determines the causes for failure of the factors. In one embodiment, a root cause analysis is used to find the causes. The root cause analysis involves using a cause and effect model to determine the cause of failure of a factor that hampered the innovation capability of the units.

Further, influencing factors, i.e., the factors that may influence the factor strength of a particular factor that failed, are identified from an influence model. The influence model illustrates a predetermined relationship between different factors to identify the factors that influence a particular factor. Thus, the influencing factors that might have caused the particular factor to fail are identified to determine if strengthening any of the influencing factors may strengthen the particular factor.

Further, in one embodiment, the assessment module may analyze the factor strength questionnaires for verifying the failed factors. The factor strength questionnaires may include multiple sets of questions that may or may not be similar to the questions provided in the maturity level questionnaire. The result of the factor strength questionnaires is assessed and compared with the details of the failed factor to ensure that the determination of the failed factors is accurate. On verification, the method proceeds further. Otherwise, the analysis may be repeated.

The details of both, the failed factors and the influencing factors, are provided to a recommendation module. The recommendation module uses recommendation data to provide recommendations that can be implemented by the unit for increasing the factor strength of each failed factor to reach the next maturity level. The recommendation data includes a recommendation set corresponding to each factor. Further, the recommendations in the recommendation set are also categorized for each level. For example, the recommendation set for resource funding will have different recommendation for each of the maturity levels and for incremental, disruptive and radical innovations. The recommendation module provides the recommendation corresponding to next maturity level for each of the failed factors. Further, the details of the failed factors and influencing factors can be used by consultants or experts to provide specific recommendations to the units. The system thus provides complete recommendations for measuring and improving the innovation capability of the unit.

Further, once the recommendations are implemented by the units, an innovation measurement module is used to evaluate innovation performance of the unit, i.e., whether the unit is innovating according to its innovation capability or not. The innovation measurement module measures the innovation performance of the unit to check if the unit is successful in its adoption of the recommendations for pursuing its innovative strategy. In one embodiment, the innovation measurement module measures the innovation performance of the unit at the end of an assessment period. For example, an assessment period of six months may be defined and the innovation performance of the unit may be measured every six months after the implementation of the recommendations. In another example, the assessment period may be defined to be of one year. The duration of the assessment period may vary from one unit to another, depending on the capability of the unit to implement the recommendations. The innovation measurement includes evaluating input innovation measures, i.e., the resources such as funds, time, tools, utilized by the units and output innovation measures, i.e., the growth in terms of products, profits, intellectual property, number of innovations, patents, income from innovation, etc.

The input innovation measures are evaluated by analyzing the maturity level questionnaires. The output innovation measures, such as, number of patents filed, profits generated from patent licensing etc., are determined by sending the innovation measurement questionnaires to a unit management, such as a chief financial officer, a financial head, a chief executing officer, of the units. Based on replies to the innovation measurement questionnaires, the innovation measurement module evaluates the output innovation measures to access the unit's growth. The innovation measurement may include multiple sets of questions that may or may not be similar to the questions provided in the maturity level questionnaires or the factor strength questionnaires.

While aspects of described systems and methods for network-based innovation can be implemented in any number of different computing systems, environments, and/or configurations, the embodiments are described in the context of the following exemplary system(s).

### Exemplary Systems

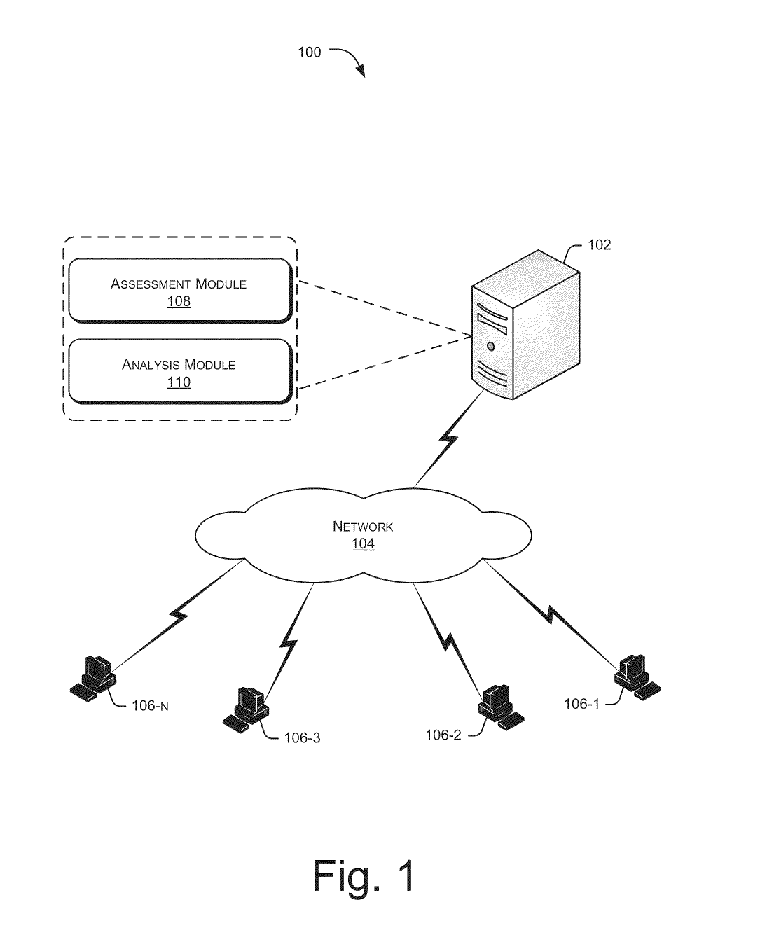

FIG. 1 illustrates an exemplary network environment 100 implementing a system and method for network-based innovation, according to an embodiment of the present invention. The network environment 100 includes a system such as a network-based innovation system 102, a network 104, and one or more units 106-1, 106-2, 106-n, collectively referred to as unit(s) 106. In one implementation, the units 106 can be different organizations, departments within a single organization, divisions, groups or teams within a department, or individual innovators within an organization. Thus, where the network-based innovation system 102 is implemented within a group of different organizations, each organization may be treated as a unit. Similarly, where the network-based innovation system 102 is implemented in a single organization, each department or division or group or team or the individual innovators may be treated as a unit. However, for the purpose of explanation, the units 106 are considered as parts of a single organization and should not be construed as a limitation. The units 106 interact with the network-based innovation system 102, hereinafter referred to as the system 102, over the network 104.

The network 104 may be a wireless network, wired network, or a combination thereof. The network 104 can also be an individual network or a collection of many such individual networks, interconnected with each other and functioning as a single large network, e.g., the Internet or an intranet. Furthermore, the network 104 includes network devices, such as network switches, hubs, routers, HBAs, for providing a link between the system 102 and the unit 106. The network devices within the network 104 interact with the system 102 and the unit 106 through communication links, such as fiber channel links and, internet small computer systems interface (iSCSI). As will be known, the system 102 may be any computing device connected to the network 104. For instance, the system 102 may be implemented as mainframe computers, workstations, personal computers, or servers for managing network resources.

The system 102 enables the units 106 develop their innovation capability, which is an ability to come up with innovations and novel ideas that deliver both short and long-term profits, on a consistent basis. The system 102 is used to identify a maturity level of the innovation capability of the unit 106. A maturity level is defined as an evolutionary plateau of innovation capability improvement. Each maturity level is like a step towards continuous improvement in the innovation capability. The maturity levels are determined by analyzing strengths or weaknesses of various innovation factors, i.e., key factors that determine the innovation capability of the units 106. The innovation factors, interchangeably referred to as factors, provide a correlation between innovation and a unit's performance regarding developing new products, solutions, and services.

The system 102 includes an assessment module 108, an analysis module 110, a recommendation module (not shown in this figure), and an innovation measurement module (not shown in this figure). The system 102 employs the various modules for taking inputs from the units 106, analyzing the inputs, and based on the analysis, providing recommendations to strengthen the innovation capability.

The assessment module 108 sends one or more questionnaires, such as maturity level questionnaires, factor strength questionnaires, and innovation measurement questionnaires to the units 106 and receives the replies to the questionnaires from the units 106. The maturity level questionnaires include multiple sets of questions, with each set corresponding to a particular factor and having questions to determine strength of the factors, i.e., factor strength. Based on the replies, the assessment module 108 determines the factor strength of each factor. The assessment module 108 uses the factor strength to determine the maturity level of the innovation capability of the units 106. The maturity level of the units 106 is the level for which the factor strength of all the factors is above a threshold value. The units 106 can move to a higher maturity level only when it meets all the criteria specified for the innovation factors in a current maturity level. The recommendation module uses a recommendation data to provide recommendations that can be implemented by the units 106 for increasing the factor strength of each factor that has factor strength less than the threshold value required to reach the next maturity level. Further, once the recommendations are implemented by the units 106, an innovation measurement module is used to evaluate innovation performance of the units 106, i.e., whether the units 106 are performing according to its innovation capability or not.

In one embodiment, six maturity levels for rating the innovation capability of the units 106 have been identified. First maturity level is an individualistic (IN) level that indicates the innovation capability of an individual innovator in the units 106. The first maturity level further indicates whether the individual innovator has the required domain knowledge, skills, and experience to be able to innovate. For example, if an organization having 100 research scientists is at first level, it means that all the 100 research scientists have the required innovation capability and the organization can work towards moving to the next, i.e., a second maturity level.

The second maturity level is a Homogeneous Team (HT) level that indicates the ability of individual innovators, having the same skill set, to work in a team. The second maturity level indicates the innovation capability of the units 106 when teams within the units 106 comprise of innovators of same skill set and diversity, i.e., cultural background, way of thinking, way of working, etc. The second maturity level further indicates that the units 106 encourage innovators with the same skill sets to form groups to come up with new ideas by interacting with one another. For example, if an organization with 100 research scientists, where 50 have a skill set of a first type and rest 50 of a second type, is identified to be at the second maturity level, it is established that the 50 research scientists having skill set of a first type and second type, respectively, can work well together as a team. Thus, the organization may have various teams with each team having research scientists of same skill set and diversity working well together as a team. The organization can now work towards moving to the next, i.e., a third maturity level.

The third maturity level is a Multidisciplinary Team (MT) level that indicates the innovation capability of the units 106 when teams within the units 106 are formed by combining innovators having different skill sets. Teams comprising of innovators having different skill sets are also known as a cross-functional teams. A cross-functional team may consist of idea providers, technical experts, development people, marketing experts, etc. The third maturity level further indicates that the unit 106 has a process in place to encourage people with different skills and knowledge to come together to develop new ideas and innovations, and to train the people on how to innovate in the multidisciplinary teams. For example, consider an organization having 100 research scientists with two groups of 50 scientists and each group having a specific type of skill set. If the organization is determined to be at the third maturity level, it implies that the research scientists having different skill sets can also work together as a team. Hence, the 50 research scientists of one group may cooperatively work with the 50 research scientists of another group, irrespective of the fact the research scientists of the two groups posses different skill sets. Thus, the organization may have various teams with each team having research scientists of different skill sets working well together. The organization can now work towards moving to the next, i.e., a fourth maturity level.

The fourth maturity level is a Diverse Team (DT) level that indicates the innovation capability of the unit 106 when teams within the unit 106 are formed by combining innovators coming from diverse background. The fourth maturity level further indicates that the unit 106 encourages innovators having different cultural background, way of thinking, manner of working, etc. to work together as a team. For example, consider an organization having 100 scientists with five groups of 20 scientists and each group having scientists from a specific background. If the organization is determined to be at the fourth maturity level, it implies that the scientists from diverse background can also work together as a team. Hence, the 20 scientists of one group may cooperatively work with the 80 scientists of other groups, irrespective of the fact the scientists of the five groups are from diverse background. The organization does not need to find research scientist of same backgrounds to make a team. The organization can now work towards moving to the next, i.e., a fifth maturity level.

The fifth maturity level is an External Units (EU) level that indicates the ability of one of the unit 106, say the unit 106-1 to work with another unit, say the unit 106-2. The fifth maturity level further indicates that the unit 106 has the innovation capability to develop a network for pro-actively sourcing ideas from individuals, customers, suppliers, vendors, academic researchers, scientists, innovation brokers, innovators from external organization, etc. For example, consider a first organization and a second organization having 100 research scientists each. If the organizations are determined to be at the fifth maturity level, it implies that the research scientists from both the organizations can work together as a team. The organization can now work towards moving to the next, i.e., a sixth maturity level.

The sixth maturity level pertains to an Optimize, Re-use, and Sustain (OS) level, which indicates that the unit 106 is continuously learning, by optimizing, re-using, and sustaining innovations.

Although the present subject matter discloses six maturity levels, it will be understood by a person skilled in the art that any number of maturity levels can be removed from or added to the present list. Further, characteristics of any of the maturity levels can be replaced according to needs of the units 106.

As previously stated, the unit 106 can move to a higher maturity level only when it meets all the criteria specified for the innovation factors in a current maturity level. In one embodiment, 15 innovation factors, i.e., collaboration, compatibility, competency, leadership, resource funding, resource tools and equipments, communication, exposure, innovation culture, innovation environment, innovation process, resource people, resource time, rewards and recognition, and team composition have been identified as necessary for rating the unit's innovation capability.

Collaboration for example, may be defined as actively looking for and working with partners, like industry, academia, clients, suppliers, vendors, etc. Collaboration is required for two or more units 106 working together to accomplish a task.

Compatibility, for example, may pertain to a degree to which two or more units 106 are capable of innovating together. It is important to check the compatibility for culture, process, policy, governance, development environment, etc.

Communication, in one example, may be defined as a process by which knowledge, thoughts, opinions, or information can exchange from one unit 106 to another unit 106. Communication is required for building interaction within units 106 members, so that they can share their thoughts, views, project details, etc in an effective manner.

Competency, for example, may define that the units 106 have domain knowledge, skills, and experiences to do an assigned innovation work. Competencies are personal characteristics and can include motives, traits, aptitude, knowledge, and skills. Competency is the ability to come up with new ideas, willing to adopt new ideas, ability to work with people from different culture, ability to learn and grasp things easily.

Exposure for example, may be defined as being aware of all the latest things happening in the area of work. The units 106, such as organizations have to provide opportunities to their individual innovators to build the knowledge on the latest trends happening in their area of work.

Innovation culture, in one example, may pertain to creating an environment that encourages innovators to come up with innovative ideas. The units 106 such as organizations have to create an environment where individual innovators feel that importance will be given to their ideas, i.e., individual innovators are involved in decision making process etc.

Innovation environment, for example, may be explained as a physical setup and eco-system made available to the units 106 for innovation. Providing an innovation environment with good research and development facilities is a necessity for innovations to happen. Innovation process means providing a well-defined process in generating ideas to make them into products and services. The innovation process can provide a route for fresh ideas to be brought up for working.

Leadership, in one example, may be defined as commitment of a team leader or a leadership team to increase innovation, define innovation strategy, build innovation capability, provide motivation and direction for innovation, and support risk taking and tolerance to failure. Strengthening the leadership factor helps in developing a dynamic leadership in each of the units individual innovators of the units 106. Dynamic leadership may be defined as an important aspect that needs to be considered where two or more units 106 are working together as network partners in the network 104. Dynamic leadership relates to sharing and handover of responsibility amongst the units 106. Each of the units 106 may be assigned specific tasks in the innovation process. For example, one of the units 106 may generate the idea while another group of the units 106 may do idea filtration. Similarly, a prototype may be developed by other units 106, etc. Accordingly, the leadership also changes with each phase of the innovation process. Hence, the dynamic leadership includes sharing responsibilities at each phase of development of an innovation, without being dependent on a single network partner, i.e., the units 106. In one embodiment, sharing and handover of responsibility amongst the units 106 may be determined based on predetermined conditions, such as beginning of a new phase of the innovation process, completion of a target time, completion of certain milestones, providing deliverables, unforeseen incident. For example, in the beginning of an innovation process, the units 106 may agree to share the responsibility of dynamic leadership among each of the units 106 such that each of the units 106 may become a leader in at least one phase of the innovation process. Based on the agreement, the system 102 may determine a leader in the innovation process.

Resource funding, for example, may be pertain to providing sufficient amount of funds for the units 106 to do innovation. Funds are the monetary capital that is invested in the entire innovation life cycle i.e. from idea generation until commercialization. Funds are needed mostly for the investment with regards to people, tools and equipments, infrastructure, etc.

Resource people, in one example, may be defined as the number of available innovative people with the right mind set to contribute to innovative work. Resource people can be individual innovators, consumers, suppliers, vendors, academic researchers, scientists, innovation brokers, and innovators from external organization. Further, a unit may also include support people such as, developers, testers, administrator, facilitators, maintenance, etc. The resource people and the support people comprise the total number of people of the units 106.

Further, a critical mass of resource people is defined to find out capability of the units 106 with regard to the resource people available with the units 106. The critical mass of resource people may be defined as a certain percentage of people doing innovative work from amongst the total number of people working in a unit. For the development of the innovation capability of the units 106 it is necessary to maintain the critical mass of resource people. The critical mass of resource people may differ from one unit 106 to another depending on a primary function of a unit 106.

In one embodiment, based on the primary functions, the units 106 may be divided into three categories; a first category may include units 106 involved in research, incubation of ideas, and developing intellectual properties. A second category may include units 106 performing product development, solutions development, and design and engineering and a third category may include units 106 providing services and manufacturing. The support people and the critical mass of resource people may be defined for each of the categories and the system 102 may be configured to determine the critical mass of resource people for the units 106 based on the category of the units 106. The categories of the units 106 described in the above embodiment are only illustrative, various other embodiments will be apparent to a person skilled in the art.

Resource time, for example, may be explained as an adequate time that is provided for the units 106 for doing innovative work. Resource tools and equipments are the adequate tools that are available for doing innovative work. A wide variety of resource tools and equipments are required at the different stages of the innovation process.

Rewards and recognition, in one example, may be defined as a well defined rewards and recognition process through which the people feel honored and excited. Team composition means the size, role, competency, and background of team members forming a team. The team may consist of innovators from different units, diversity, geography, multidisciplinary, different levels of seniority, etc. Team composition includes various challenges such as getting people with diversity, different unit, geography and multidisciplinary to work together.

Although the present subject matter discloses the above mentioned innovation factors, it will be understood by a person skilled in the art that any number of innovation factors can be removed from or added to the present list. Further, according to needs of the units 106, any of the innovation factors can be replaced by another innovation factors.

Further, the system 102 also evaluates whether the unit 106 is progressing towards an incremental innovation, a disruptive innovation, or a radical innovation. The incremental innovation is a gradual improvement of an existing technology, service, product, process, etc. The incremental innovations provide products that offer new features, benefits, or improvements to the existing technology in the existing market. The disruptive innovation is a technology that unexpectedly displaces the existing technology in the market. The disruptive innovation involves producing a completely new product that brings new dimensions to the existing product, or a completely new way to produce or distribute existing products, or a completely new way to provide services.

Further, the radical innovation means exploration of new technology. The radical innovation creates a dramatic change in products, processes, services that transform existing markets or industries, or create new ones. The radical innovation can thus often open up completely new markets and potential applications. In one embodiment, the maturity level for each of the incremental, disruptive, and radical innovation can be identified. The system 102 thus helps the units 106 in building innovation capability for each of the incremental, disruptive and radical innovation. Building innovation capability, while keeping in view the types of innovation, is necessary for the units 106 to sustain their position in the growing competitive world.

In one embodiment, it may be important to recognize the type of innovation the units 106 want to follow before implementing the system 102. Recognizing the type of innovation is important as the characteristics of each type of innovations are different. Thus making it essential to define the maturity level for each of the incremental, disruptive, and radical innovation. Similarly, the recommendations provided to strengthen the failed factors are based on the innovation types. For example, if one of the units 106, say the unit 106-1 wants to focus on incremental type of innovation, then the maturity level of the unit 106-1 for incremental innovation is assessed and corresponding recommendations to strengthen the failed factors for incremental innovation is provided. Prior determination of the innovation type greatly simplifies the application of network based innovation, thereby leading to successful building of innovation capabilities for the units 106.

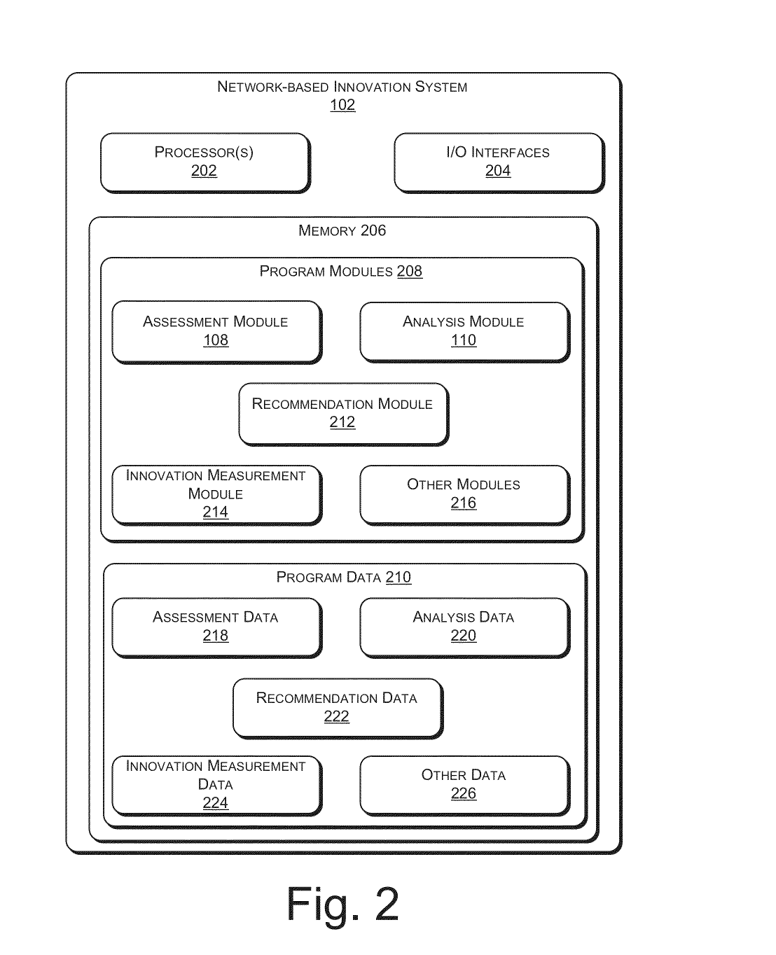

FIG. 2 illustrates exemplary components of the system 102, according to an embodiment of the present subject matter. The system 102 includes one or more processor(s) 202, I/O interface(s) 204 and a memory 206. The processor(s) 202 can be a single or multiple processing units. The processor(s) 202 can be implemented as one or more microprocessors, microcomputers, microcontrollers, digital signal processors, central processing units, state machines, logic circuitries, or any devices that manipulate signals based on operational instructions. Among other capabilities, the processor(s) 202 are configured to fetch and execute computer-readable instructions and data stored in the memory 206.

The I/O interfaces 204 may include a variety of software and hardware interfaces, for example, interface for peripheral device(s) such as a keyboard, a mouse, an external memory, a printer, etc. Further, the I/O interfaces 204 may enable the system 102 to communicate with other computing devices, such as web servers and external databases. The I/O interfaces 204 may facilitate multiple communications within a wide variety of protocols and networks, such as the network 104, including wired networks, e.g., LAN, cable, etc., and wireless networks, e.g., WLAN, cellular, satellite, etc. For the purpose, the I/O interfaces 204 may include one or more ports for connecting to a number of computing devices, such as the units 106.

The memory 206 can include any computer-readable medium known in the art including, for example, volatile memory (e.g., RAM) and/or non-volatile memory (e.g., flash, etc.). The memory 206 also includes program module(s) 208, and program data 210. The program module 208 includes routines, programs, objects, components, data structure, etc., that perform particular task or implement particular abstract data types. In one implementation, the program module 208 includes the assessment module 108, the analysis module 110, a recommendation module 212, an innovation measurement module 214, and other module(s) 216. Other module(s) 216 includes programs that supplement applications implemented by the system 102.

The data 210 includes an assessment data 218, an analysis data 220, a recommendation data 222, an innovation measurement data 224 and other data 226. The other data 226 includes data that is generated as a result of the execution of one or more modules in the other modules 216.

As indicated previously, the assessment module 108 sends an input request having one or more questionnaires, such as maturity level questionnaires, factor strength questionnaires, and innovation measurement questionnaires to the units 106 over the network 104. In one embodiment, separate maturity level questionnaires for each of the incremental, disruptive, and radical innovation can be sent to identify the maturity level for each of the innovations. The maturity level questionnaires include multiple sets of questions, with each set corresponding to a particular factor and having questions to determine strength of the factors. The questions may correspond to various maturity levels. Inputs, i.e., the replies from the units 106 in response to the maturity level questionnaires are received by the assessment module 108 and stored in the assessment data 218.

Based on the replies, the assessment module 108 determines the strength of each factor. For the purpose, the assessment module 108 assesses the inputs and calculates a score of each factor. The assessment module 108 then uses a threshold method that involves determining factor strength for each maturity level by comparing the score with a threshold value corresponding to the maturity level. The threshold value is defined for each maturity level and the score is compared with each of the threshold values. If the score for a particular factor is equal to or above the threshold value for a particular maturity level, then the factor strength is termed as a high factor strength, i.e., the factor strength is strong for the particular maturity level and the factor is said to have passed the particular maturity level. Otherwise, the factor strength is termed as a low factor strength, i.e., the factor strength is weak for the particular maturity level and the particular factor is said to have failed for that particular maturity level.

For instance, a maturity level questionnaire sent to the units 106 may include a set of questions corresponding to each of the 15 factors. A set of question corresponding to a factor, say, collaboration may have six questions with each question corresponding to a different maturity level. For example, corresponding to the factor collaboration, a maturity level questionnaire for disruptive innovation may have a question to determine whether there exists a process for multidisciplinary team to do disruptive innovation. Similarly, corresponding to the factor communication, a question to enquire whether there are tools to enable interaction between the multidisciplinary team may be included.

Similarly, a maturity level questionnaire for incremental innovation may have a question to ascertain whether there is a process for individuals working in diverse team to come up with incremental innovation, corresponding to the factor collaboration and similarly a question relating to tools for interaction with diverse team members, corresponding to the factor communication.

A maturity level questionnaire for incremental innovation may, corresponding to the factor collaboration, have a question to determine whether there is a process that would connect radical thinkers within unit. Likewise, corresponding to the factor communication, a question pertaining to meetings conducted among stakeholders for the purposes of discussing radical ideas, may be included.

On receiving the replies to the questionnaire, replies of the questions corresponding to collaboration are evaluated to determine a score for collaboration at each of the maturity level. The score is then compared with a threshold value that is predefined for each maturity level. As an example, the first maturity level may have a threshold value of 60 marks. If the score of collaboration is greater than or equal to 60 marks, then collaboration is said to have passed the first maturity level.

Thus, all the maturity levels that are having a high factor strength for each of the factors are identified and the highest maturity level for which all the factors have a high factor strength is selected as a current maturity level of the innovation capability of the unit 106. For example, if all the factors clear the threshold value of third level, but only 11 factors clear the threshold value of fourth level, then the innovation capability of the unit 106 is said to be at the third maturity level. In one embodiment, the maturity level for each of the incremental, disruptive, and radical innovation can be identified. Details about the score and the factor strength for each of the factors are stored in the assessment data 218.

The analysis module 110 then analyzes the factor strength details from the assessment data 218. The analysis module 110 analyzes the factor strength details to identify weak factors, i.e., the factors that failed for a maturity level and determines the factors that need to be strengthened to enable the unit's innovation capability reach next maturity level on the maturity level model. For example, if the unit 106 is at the third maturity level, then the analysis module 110 determines all the factors that failed to clear the threshold value of the fourth maturity level.

The analysis module 110 prepares a factor matrix having the score of each factor marked against respective maturity levels. Based on the factor matrix, the analysis module 110 identifies the failed factors and determines the causes for failure of the factors. In one embodiment, a root cause analysis model is used to find the causes. The root cause analysis involves using a cause and effect model that shows the various factors that lead to the failure of the innovation capability in reaching a higher maturity level. The results of the cause analysis may be stored in the analysis data 220 for any future reference.

Further, influencing factors, i.e., the factors that may influence the factor strength of a weak factor, are ascertained from an influence model stored in a database internal or external to the system 102. In one embodiment, the influence model may be stored in the analysis data 220 and accessed by the analysis module 110 to identify the influencing factors. The influence model illustrates a predetermined relationship between different factors to identify the factors that influence a particular factor. In one embodiment, the factors may be strongly related, moderately related, or loosely related. For example, resource tools and equipments may be influenced by factors such as resource funding, collaboration, and competency. The influence of the influencing factors that might have caused the particular factor to fail is identified to determine if strengthening any of the influencing factors may strengthen the particular factor. The factor matrix and the details of both, the failed factors and the influencing factors, is then stored in the analysis data 220 and provided to the recommendation module 212. In one embodiment, the factor matrix may also be provided to the units 106 though the network 104.

Further, in one embodiment, the assessment module 108 may send the factor strength questionnaires to the units 106 for verifying the analysis data 220, i.e., the failed factors. The factor strength questionnaires may include multiple sets of questions, with each set corresponding to a particular innovation factor and having questions to determine strength of the innovation factors. The questions may or may not be similar to the questions provided in the maturity level questionnaire. For example, a factor strength questionnaire sent to the units 106 may have a question to determine whether there is a process to share work culture between different units.

A factor strength input received from the units 106 in reply to factor strength questionnaires is assessed and compared with the analysis data 220 to ensure that the identification of the weak factors is accurate. On verification of the analysis data 220, analysis data 220 is provided to the recommendation module 212. Otherwise, the analysis may be repeated.

The recommendation module 212 uses the analysis data 220 to identify the weak factors to provide recommendations that can be implemented by the units 106 for increasing the factor strength of each weak factor to reach the next maturity level. For the purpose, the recommendation module 212 may access the recommendation data 222 that includes a recommendation set corresponding to each factor. For example, the recommendation data 222 may include 15 recommendation sets, with one recommendation set corresponding to one of the 15 factors. Further, each recommendation set will have different recommendations corresponding to different maturity levels. Thus, the recommendation set for resource funding will have different recommendations for the first and the second level.

Based on the analysis data 220, the recommendation module 212 identifies the next maturity level that the unit 106 needs to reach, and then selects recommendations corresponding to the next maturity level for each of the weak factors. Further, the recommendations may also be based on the influencing factors that were identified to be influencing the weak factors. The recommendation module 212 then provides a recommendation output having the recommendations to the units 106 through the network 104.

Further, the details of the weak factors and the influencing factors can be used by consultants or experts to provide specific recommendations to the units 106. The system 102 thus provides complete recommendations for measuring and improving the innovation capability of the units 106.

The system 102 can further perform an analysis of strength(S), areas of improvement(W), opportunities(O), and threat(T) (SWOT), i.e., a SWOT analysis on the factors. For the purpose, the assessment module 108 analyzes the replies of the maturity level questionnaire. The results of the SWOT analysis are provided to the units 106. In one embodiment, the assessment module 108 may use the threshold method for performing the SWOT analysis.

In another embodiment, the assessment module 108 may use a set of predefined rules for performing the SWOT analysis. The predefined set of rules for SWOT analysis may include various rules to identify the factors as strength, areas of improvement, opportunity, and threats for a unit, such as the unit 106. Strength of a unit, in one example, may be defined as the factors in which the unit excels, for example, the assessment module 108 may identify all the factors that are at the sixth maturity level as strength factors, i.e., strength of the unit 106. Areas of improvement for a unit, in one example, may be defined as the factors, which the unit 106 needs to strengthen to improve its innovation capability, for example, the factors that have failed at first maturity level may be identified improvement factor, i.e., as areas of improvement for the unit 106.

Opportunities for a unit may be identified for factors as well as maturity levels, for example, a particular factor that is weak for a single, i.e., only one maturity level may be identified as opportunity factor for the unit 106, i.e., the unit 106 has an opportunity of excelling in the particular factor. Similarly, if there are only two or lesser number of factors which have failed at a particular maturity level, then maturity level may be defined as opportunity level for the unit 106, to indicate that the unit 106 has an opportunity of achieving that particular level.

Threat factors that are indicative of threats for a unit, in one example, may be identified by comparing its factor strength and maturity level with another unit working in the same category of primary function as the unit under consideration, as described previously. For example, if the unit 106-1 and the unit 106-2 are two units having the same primary function, say providing services and/or manufacturing and are at the same maturity level, for example the third maturity level. The unit 106-1 may be identified as a threat to the unit 106-2 if the unit 106-1 satisfies certain predefined condition defined using preconfigured threat analysis rules. The preconfigured threat analysis rules may be, for example, a first preconfigured threat analysis rule defining that the unit 106-1 may be identified as a threat to the unit 106-2 if a predefined percentage, for example, about 47% of total factors of the unit 106-1 pass the next maturity level, i.e., the fourth maturity level. Similarly, a second preconfigured threat analysis rule may include identifying, for each maturity level above the current maturity level and up to the highest maturity level, the factors having high factor strength. If sum of the factors identified for the unit 106-1 is 80% more than sum of the factors identified for the unit 106-2, the unit 106-1 may then be identified as a threat to the unit 106-2. For example, if the unit 106-1 and the unit 106-2 are at the third maturity level, then all the factors that have high factor strength at fourth, fifth, and sixth maturity levels of the unit 106-1 and the unit 106-2 will be identified. Say, for the unit 106-2, number of factors having high factor strength at the fourth maturity level is 8, at the fifth maturity level is 5, and at the sixth maturity level is 2, thus the sum of the factors identified for the unit 106-2 is 15. If the sum of the factors identified for the unit 106-1 is more than 27, i.e., (15+80% of 15), then the unit 106-1 meets the second predefined condition. In one embodiment, the first preconfigured threat analysis rule and the second preconfigured threat analysis rule may be applied in conjunction and accordingly an unit qualifying both the conditions will be identified as a threat to another unit. In another embodiment, the first preconfigured threat analysis rule and the second preconfigured threat analysis rule may be applied independently. Accordingly an unit qualifying any one of the conditions may be identified as a threat to another unit. It will be appreciated that the first and the second preconfigured threat analysis rule are only examples and should not be construed as a limitation. Various similar rules will be apparent to a person skilled in the art. Thus, the unit 106-1 may be identified as a threat factor to the unit 106-2 if the unit 106-1 satisfies the preconfigured threat analysis rules. Further, the assessment module 108 performs the SWOT analysis for each of the incremental, disruptive, and radical innovation.

Further, once the recommendations are implemented by the units 106, the innovation measurement module 214 is used to measure innovation performance of the units 106, i.e., it is ascertained whether the units 106 are innovating according to their innovation capability or not. The innovation measurement module 214 measures the innovation performance of the units 106 to check if the units 106 are successful in adopting the recommendations for pursuing their innovative strategy. The innovation measurement includes evaluating input innovation measures, i.e., the resources such as funds, time, tools, utilized by the units 106 and output innovation measures, i.e., the growth in terms of products, profits, intellectual property, number of innovations, patents, income from innovation, etc.

The input innovation measures may be calculated by evaluating factor strength of the factors and the maturity level of the innovation capability of the units 106. For the purpose, the innovation measurement module 214 sends the maturity level questionnaires to the units 106 and receives replies in response to the questionnaire. Based on the replies, the innovation measurement module 214 evaluates the factor strength of the factors and the maturity level of the innovation capability to calculate the input innovation measures. In one embodiment, the analysis data 220 may be used for calculating the input innovation measures. The input innovation measures are then stored in the innovation measurement data 224. The innovation measurement data 224 is then compared with the assessment data 218 to evaluate how the input innovation measures have improved for the units 106.

The output innovation measures are calculated by sending the innovation measurement questionnaires to a unit management personnel, such as a chief financial officer, a financial head, a chief executing officer, of the units 106. Based on replies to the innovation measurement questionnaires, the innovation measurement module 214 evaluates the unit's growth to calculate the output measures. In one embodiment, an assessment period may be defined for sending the innovation measurement questionnaires to the units 106. The units 106 may be sent the innovation measurement questionnaires at the end of each assessment period to measure the output innovation measures. For example, an assessment period of six months may be defined and the innovation measurement questionnaires may be sent every six months.

The assessment period may be predefined or configured according to the requirements of the units 106. The innovation measurement module 214 may send the innovation measurement questionnaires for the first time at the beginning, i.e., before applying the network-based innovation. Based on the replies to the innovation measurement questionnaire, the innovation measurement module 214 evaluates the unit's growth to calculate the output measures at the beginning The output measures at the beginning are then stored in the innovation measurement data 224.

The innovation measurement module 214 may also send the innovation measurement questionnaires when the recommendations have been implemented by the units 106. The innovation measurement questionnaire includes questions for determining the unit's growth after implementation of the recommendations. For example, the innovation measurement questionnaire may include a question to determine number of innovations which have provided new dimensions in the space of products during the assessment period and a question to determine number of people engaged in doing innovative work in the unit during the assessment period. The innovation measurement questionnaires may be sent at the end of each assessment period, for example, six months after the implementation of the recommendations. Based on the replies to the innovation measurement questionnaires, the innovation measurement module 214 may evaluate the unit's growth to calculate the output measures. The output measures after the implementation of the recommendations are the stored in then innovation measurement data 224. The innovation measurement module 214 may further compare the output innovation measures at the beginning with the output measures after the implementation to evaluate how the output innovation measures have improved for the units 106.

Measuring the input innovation measurements and output innovation measure is needed as the both the innovation measures are interrelated and to be improved for the increasing the innovation capability of the units 106. For example, if the input innovation measures are determined to be strong, i.e., the innovation maturity level is high then the expectation of high output innovation measures as results follow.

### Exemplary Methods

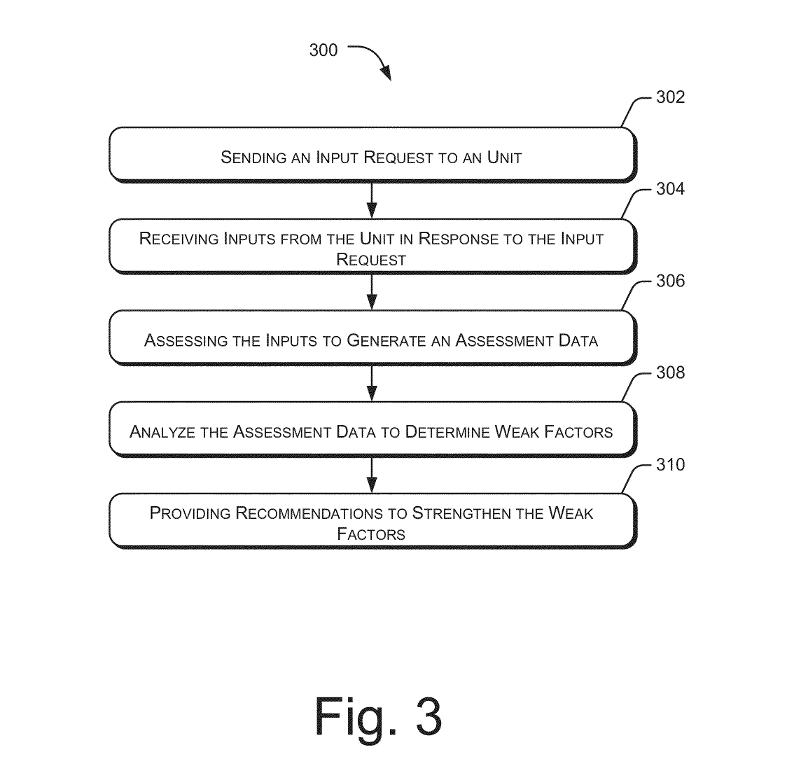

FIG. 3 illustrates an exemplary method 300 for the network-based innovation, according to an embodiment of the present subject matter. The exemplary method 300 may be described in the general context of computer executable instructions. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communication network. In a distributed computing environment, computer executable instructions may be located in both local and remote computer storage media, including memory storage devices.

The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 302, an input request is sent to a unit, such as the unit 106, by an assessment module, for example, the assessment module 108. In one embodiment, the assessment module 108 sends one or more maturity level questionnaires to the units 106 over the network 104. The maturity level questionnaires include multiple sets of questions, with each set corresponding to a particular innovation factor and having questions to determine strength of the innovation factors, i.e., factor strength.

At block 304, inputs are received from the units 106, in response to the input request, by the assessment module 108. Further, in one embodiment, on receiving the replies the assessment module 108 may send the factor strength questionnaires to the units 106. The replies to the factor strength questionnaires may be received by the assessment module 108 and stored for further analysis.

At block 306, the inputs are assessed to generate an assessment data, for example, the assessment data 218. In one embodiment, the assessment module 108 assesses the inputs, to generate the assessment data 218. The assessment data 218 is generated to identify a maturity level of the innovation capability of the units 106. The maturity levels are identified by analyzing strengths or weaknesses of various innovation factors, i.e., key factors that determine the innovation capability of the units 106. The assessment module 108 determines the factor strength to identify the maturity level. For the purpose, a score of each factor is assessed for each maturity level and compared with a threshold value defined for that particular maturity level to determine the factor strength of each of the innovation factors.

At block 308, the assessment data 218 is analyzed to determine weak factors, i.e., the innovation factors having the low factor strength. In one embodiment, the analysis module 110 analyzes the factor strength details from the assessment data 218. The analysis module 110 analyzes the factor strength details to identify weak factors, i.e., the factors that failed for a maturity level and determines the factors that need to be strengthened to enable the unit's innovation capability reach next maturity level on the maturity level model. Further, the replies of the factor strength questionnaires is assessed and compared with the analysis data 220 to verify whether the analysis of the failed factors is correct or not. On verification of the analysis data 220, the method proceeds to the block 310. Otherwise, the analysis at the blocks 306 and 308 may be repeated.

At block 310, recommendations for strengthening the weak factors are provided to the unit 106. In one embodiment, the recommendation module 212 uses the recommendation data 222 to provide recommendations that can be implemented by the unit 106 for increasing the factor strength of each factor, which has a factor strength less than the threshold value required to reach the next maturity level.

Although embodiments for a network-based innovation system have been described in language specific to structural features and/or methods, it is to be understood that the invention is not necessarily limited to the specific features or methods described. Rather, the specific features and methods are disclosed as exemplary implementations for the network-based innovation system.

I/we claim:

1. A method for innovation management performed by a network-based innovation system, the method comprising:
assessing inputs, received by the network-based innovation system, from a unit, to calculate a score of each of a plurality of innovation factors, wherein each of the innovation factors is one selected from a group comprising collaboration, compatibility, competency, leadership, resource funding, resource tools and equipments, communication, exposure, innovation culture, innovation environment, innovation process, resource people, resource time, rewards and recognition, and team composition;
determining, by the network-based innovation system, a factor strength for each of a plurality of innovation maturity levels, corresponding to each of the plurality of innovation factors based at least in part on the score, wherein the factor strength is one of a high factor strength and a low factor strength; and
ascertaining, by the network-based innovation system, a current innovation maturity level of the unit based at least in part on the factor strength of each of the plurality of innovation factors.

2. The method as claimed in claim 1, wherein the determining comprises comparing the score of each of the plurality of innovation factors, for each of the plurality of innovation maturity levels, with a threshold value corresponding to each of the plurality of innovation maturity levels.

3. The method as claimed in claim 1, wherein the ascertaining comprises:
identifying at least one innovation maturity level from among the plurality of innovation maturity levels having the high factor strength for each of the plurality of innovation factors; and
selecting a highest innovation maturity level from among the at least one innovation maturity level, wherein the highest innovation maturity level corresponds to the current innovation maturity level.

4. The method as claimed in claim 1 further comprising:
sending, by the network-based innovation system, an input request to the unit, wherein the input request includes at least one questionnaire having a plurality of questions corresponding to the plurality of innovation factors; and
receiving, by the network-based innovation system, the inputs in response to the input request, from the unit.

5. The method as claimed in claim 1 further comprising:
identifying, by the network-based innovation system, based at least in part on the factor strength, at least one weak factor from among the plurality of innovation factors, wherein the weak factor has the score less than a threshold value corresponding to an innovation maturity level;
providing, by the network-based innovation system, recommendations to strengthen the at least one weak factor; and
measuring, by the network-based innovation system, an innovation performance of the unit upon implementation of the recommendations.

6. The method as claimed in claim 1, wherein the current innovation maturity level is ascertained for incremental, disruptive, and radical innovations.

7. The method as claimed in claim 1 further comprising applying, by the network-based innovation system, a set of predefined rules for performing a strength(S), areas of improvement(W), opportunities(O), and threat(T) (SWOT) analysis of the plurality of innovation factors.

8. The method as claimed in claim 7, wherein applying a set of predefined rules comprises:
identifying, by the network-based innovation system, one or more innovation factors from among the plurality of innovation factors having the high factor strength for a highest innovation maturity level from among the plurality of innovation maturity levels, as strength factors for the unit.

9. The method as claimed in claim 7, wherein applying a set of predefined rules comprises:
identifying, by the network-based innovation system, one or more innovation factors from among the plurality of innovation factors having a low factor strength for a lowest innovation maturity level from among the plurality of innovation maturity levels, as improvement factors for the unit.

10. The method as claimed in claim 7, wherein applying a set of predefined rules comprises:
identifying, by the network-based innovation system, an innovation maturity level from among the plurality of innovation maturity levels having the low factor strength for less than three innovation factors from among the plurality of innovation factors as an opportunity level for the unit.

11. The method as claimed in claim 7, wherein applying a set of predefined rules comprises:
identifying, by the network-based innovation system, at least one innovation factor from among the plurality of innovation factors having the low factor strength for a innovation maturity level from among the plurality of innovation maturity levels as an opportunity factor for the unit.

12. The method as claimed in claim 7, wherein applying a set of predefined rules comprises:
applying, by the network-based innovation system, preconfigured threat analysis rules to identify threat factors for the unit.

13. The method as claimed in claim 1, wherein the leadership comprises dynamic leadership for each phase of an innovation process.

14. A method for innovation management performed by a network-based innovation system, the method comprising:
generating, by the network-based innovation system, an assessment data, wherein the assessment data includes a score and a factor strength for each of a plurality of innovation factors;
identifying, by the network-based innovation system, at least one weak factor from the plurality of innovation factors based on the assessment data; and
providing, by the network-based innovation system, recommendations to strengthen the at least one weak factor.

15. The method as claimed in claim 14 further comprising:
ascertaining, by the network-based innovation system, an influencing factor, from an influence model, for the at least one weak factor; and
determining, by the network-based innovation system, influence of the influencing factor on the factor strength of the at least one weak factor.

16. The method as claimed in claim 15, wherein the recommendations are based at least in part on the influencing factor.

17. The method as claimed in claim 14 further comprising verifying, by the network-based innovation system, the identification of the at least one weak factor based on a factor strength input.

18. The method as claimed in claim 14, wherein the generating comprises:
assessing, by the network-based innovation system, inputs received from a unit, to calculate the score of each of the plurality of innovation factors;
determining, by the network-based innovation system, the factor strength, for each of a plurality of innovation maturity levels, corresponding to each of the plurality of innovation factors based at least in part on the score; and
ascertaining, by the network-based innovation system, a current innovation maturity level of the unit based at least in part on the factor strength of each of the plurality of innovation factors.

19. The method as claimed in claim 14 further comprising measuring an innovation performance of a unit upon implementation of the recommendations.

20. The method as claimed in claim 19, wherein the measuring comprises:
evaluating, by the network-based innovation system, input innovation measures for the unit; and
evaluating, by the network-based innovation system, output innovation measures of the unit.

21. The method as claimed in claim 14, wherein the assessing further comprises ascertaining a current innovation maturity level of a unit based at least in part on the factor strength.

22. The method as claimed in claim 21, wherein the current innovation maturity level is ascertained for incremental, disruptive, and radical innovations.

23. The method as claimed in claim 14 further comprising applying, by the network-based innovation system, a set of predefined rules for performing a strength(S), areas of improvement(W), opportunities(O), and threat(T) (SWOT) analysis of the plurality of innovation factors.

24. A system comprising:
a processor; and
a memory coupled to the processor, the memory comprising,
an assessment module, configured to assess inputs received from a unit, to determine a factor strength of each of a plurality of innovation factors, wherein each of the innovation factors is selected from the group consisting of collaboration, compatibility, competency, leadership, resource funding, resource tools and equipments, communication, exposure, innovation culture, innovation environment, innovation process, resource people, resource time, rewards and recognition, and team composition; and
an analysis module, configured to analyze the factor strength to identify at least one weak factor from the plurality of innovation factors.

25. The system as claimed in claim 24 further comprising a recommendation module configured to provide a recommendation output, wherein the recommendation output includes at least one recommendation to strengthen the at least one weak factor.

26. The system as claimed in claim 24 further comprising an innovation measurement module configured to measure an innovation performance of the unit having implemented the at least one recommendation.

27. The system as claimed in claim 24, wherein the assessment module is further configured to ascertain a current innovation maturity level of the unit.

28. The system as claimed in claim 24, wherein the analysis module is further configured to identify influencing factors for the at least one weak factor.

29. The system as claimed in claim 24, wherein the system is configured to determine a critical mass of resource people of the unit.

30. The system as claimed in claim 24, wherein the assessment module is configured to perform a strength(S), areas of improvement(W), opportunities(O), and threat(T) (SWOT) analysis of the plurality of innovation factors.

31. The system as claimed in claim 24, wherein the system is configured to determine, a leader for each phase of an innovation process.
